(19) United States
(12) Patent Application Publication
(10) Pub. No.: US 2016/0096297 A1
(43) Pub. Date: Apr. 7, 2016

(54) MOLDING TOOL AND METHOD FOR THE PRODUCTION OF AN OPTICAL ELEMENT

(71) Applicant: ENGEL AUSTRIA GmbH, Schwertberg (AT)

(72) Inventors: Josef GIESSAUF, Perg (AT); Christian MAIER, Linz (AT)

(21) Appl. No.: 14/874,806

(22) Filed: Oct. 5, 2015

(30) Foreign Application Priority Data
Oct. 6, 2014 (AT) A 50712/2014

(51) Int. Cl. B29C 45/16; B29C 45/72; B29C 45/04

(52) U.S. Cl. CPC B29C 45/162; B29C 45/045; B29C 45/1628; B29C 45/7207; B29L 2011/0016

(57) ABSTRACT

A molding tool for producing an optical element includes a first mold half, a second mold half separated from the first mold half by a separation plane, a first injection station arranged at the separation plane for shaping a first layer of the optical element, a second injection station arranged at the separation plane in which a second layer can be injected on to the first layer, and a first transport device for transporting the first layer from the first injection station into the second injection station. A third injection station is arranged at the separation plane, and a third layer of the optical element to be produced is injected on to the first layer and/or the second layer. The first layer and the second layer are transported from the second injection station to the third injection station by a separate second transport device.

The present invention concerns a molding tool for the production of an optical element, in particular a lens, having the features of the classifying portion of claim 1, and a process for the production of an optical element in accordance with the features of the classifying portion of claim 16.

It is known from AT 505321 A1 to the present applicant that for example lenses can advantageously be injection molded in three layers. Division into two layers is not advantageous as the production of two lenses in a respective single cavity is more effective. Production of a two-layer lens is disclosed for example in EP 1785255 A1.

EP 0839636 A2 shows a manufacture of a lens in three steps, wherein a core of the lens is produced, the core is then placed in a molding tool and then a finished lens surface is melt-welded firstly to one side and then to the other side. That admittedly has the advantage of a three-layer structure. There is the disadvantage however that considerable effort has to be applied for transporting the preliminary molding into the molding tool so that even with this implementation it is possible to achieve only a slightly improved level of economic efficiency in comparison with a two-layer lens structure.

The object of the invention is to provide a molding tool and a process which make it possible to produce a three-layer or multi-layer lens in a simpler fashion in comparison with the state of the art.

In regard to the molding tool that object is achieved by the features of claim 1. In regard to the process that is attained with the features of claim 16.

A core aspect of the invention involves producing the three-layer lens in three separate injection stations which are arranged in a (single) separation plane of the molding tool.

The term separation plane is used in this respect to denote that surface at which halves of the molding tool meet. That surface does not have to be flat but can also be curved or can involve steps. The only criterion is that the cavities of the injection stations are produced by the mold halves coming together at the separation plane. Naturally a molding tool according to the invention does not have to comprise only the two mold halves. It will be appreciated that molding tools according to the invention may also include further parts like sliders, ejectors and many other movable and immovable parts. In particular the first and/or the second transport device can also be part of the molding tool.

Arranging the at least three injection stations in a separation plane affords a considerable simplification in terms of technical complication and expenditure which has to be done to convey the respective injection molded layers into the next cavities. In addition in that way the residual heat which is present in the tool can have a positive effect on layer adhesion.

The invention makes it possible to produce three-layer or multi-layer optical elements with a single injection assembly. Naturally the optical elements can also be produced with any number of injection assemblies.

A further advantage of arranging the injection stations in one plane is that white and clean room conditions can be more easily implemented.

Advantageous embodiments of the invention are defined in the appendant claims.

It can be provided that the third injection station is so designed that the third layer can be injected in the third injection station on a side of the first layer, that faces away from the second layer. In comparison with a configuration in which for example outer layers of a lens are injected at the same time, such an embodiment has the great advantage that melt flows do not have to be balanced out. For, if a melt flow comes in too early or exerts an excessively high pressure the preliminary molding can break or otherwise suffer damage. The applicant's investigations have shown that the complication and effort which has to be undertaken to prevent that is considerable.

This embodiment makes it possible in particular to produce the first layer with relatively low precision as any deviations or shrink marks are covered over by the second and third layers and thus do not have any detrimental effects.

It can be provided that the first injection station is adapted to produce the first layer in at least two sub-layers. In that respect it may be important that the last sub-layer which completes the first layer is produced in the first injection station. It will be appreciated that it is also possible to arrange more than three injection stations in a separation plane and to produce the optical element in more than three layers or sub-layers.

The first transport device can include a handling robot, by means of which the first layer can be transported from the first injection station to the second injection station. That makes it possible for the first layer to be put into a cooling station before it is transported to the second injection station. This is also possible with a structure in which the first transport device includes a turntable, by means of which the first layer can be transported from the first injection station to the second injection station. An advantage of using a handling robot can here be that the length of the cooling operation—or the number of cycles over which cooling is effected—is adjustable while with a turntable the complete cycle time has to be altered to adapt the cooling time. That disadvantage can be avoided with a cooling station arranged outside the molding tool.

In regard to transport to the third injection station it can be provided that the second transport device is adapted to move a part of the second injection station, that shapes the second layer, for transport of the first layer together with the second layer injected thereon, to the third injection station. In that way it can be provided that surfaces of the finished optical element are removed from the mold only once and do not have to be put into a mold cavity again after removal from the mold. More specifically that can lead to damage to the surfaces, which would naturally be detrimental precisely in the case of optical elements.

Particularly when it is provided that a part which produces the shape for the second layer is used for transport to the third injection station, it can be particularly advantageous if the second transport device includes a turntable by means of which the first layer can be transported together with the second layer injected thereon from the second injection station into the third injection station. That represents a particularly simple embodiment. When it is provided a part which produces the shape of the second layer is used for transport to the third injection station, by means of which the first layer can be transported together with the second layer injected thereon from the second injection station into the third injection station, it is also possible to use a handling robot instead of the turntable.

It can be provided that two or more lenses are produced at the same time, that is to say two or more layers of respective separate optical elements are respectively produced in the injection stations. That can be advantageous for example in the production of lenses for vehicle headlights as they are required in pairs.

In general terms:

It can be provided that the injection stations are all formed by a common tool, but each injection station can also be formed by its own specific tool. The turntable can be both a component part of the machine and also of the tool.

Protection is also claimed for an injection molding machine having a molding tool according to the invention.

Further advantages and details of the invention will be apparent from the Figures and the related specific description. In the drawing:

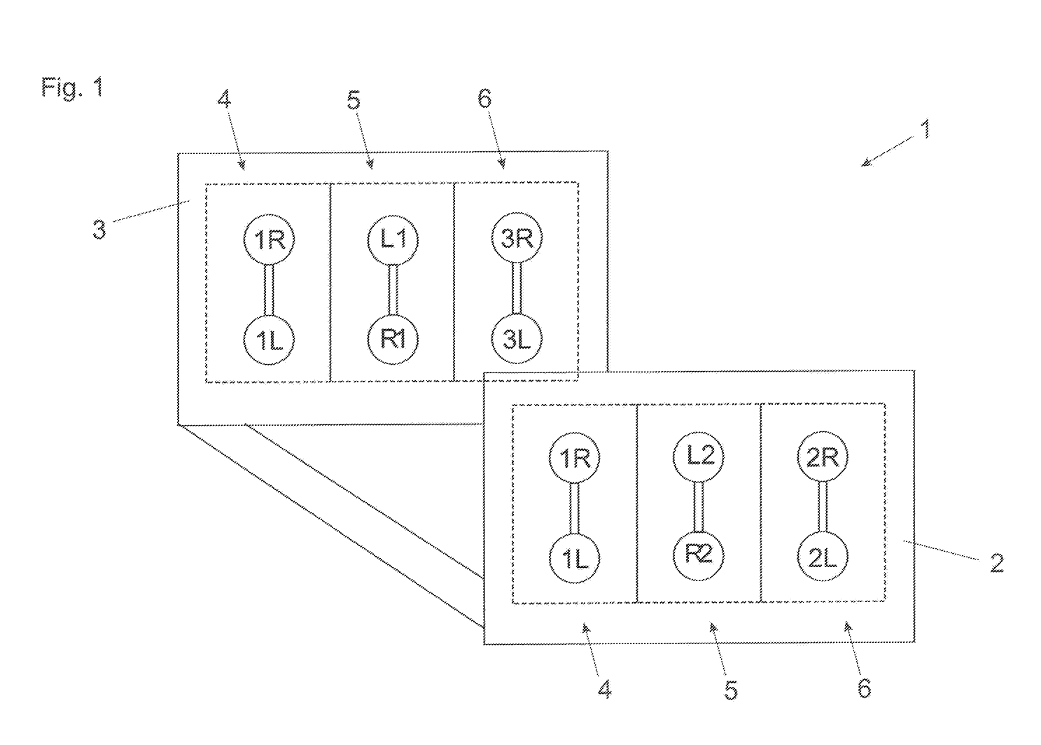

FIG. 1 shows a diagrammatic view of a molding tool for the production of an optical element having three injection stations arranged in a separation plane,

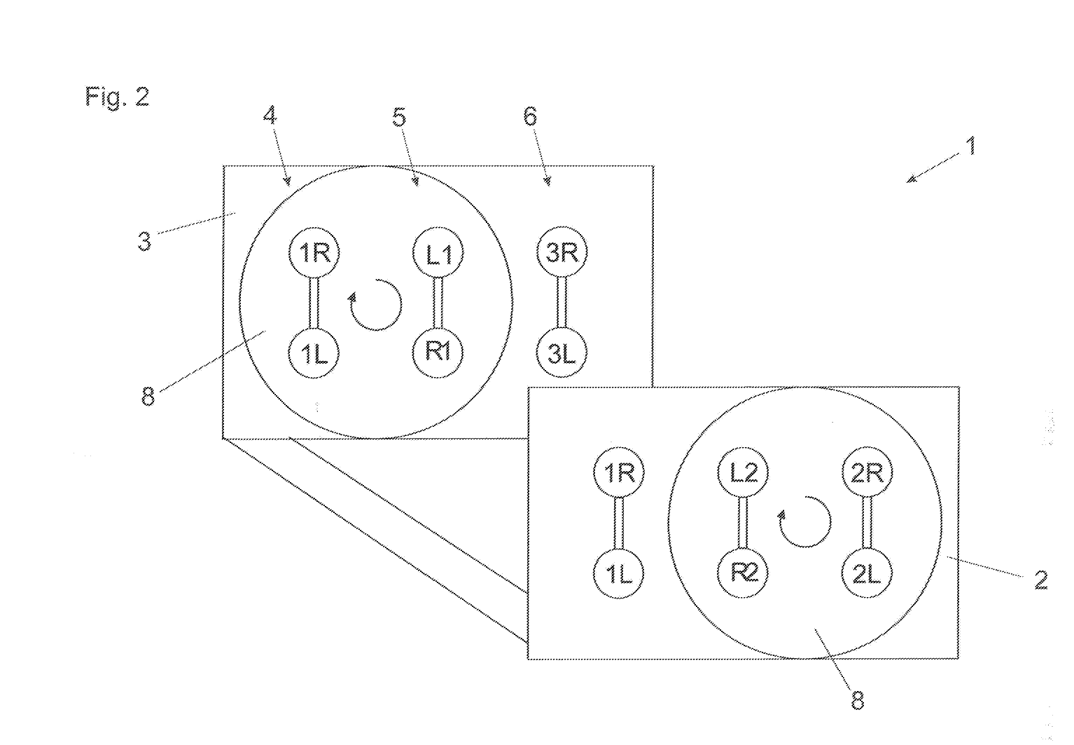

FIG. 2 shows an embodiment of the invention, wherein the first and the second transport devices have two turntables,

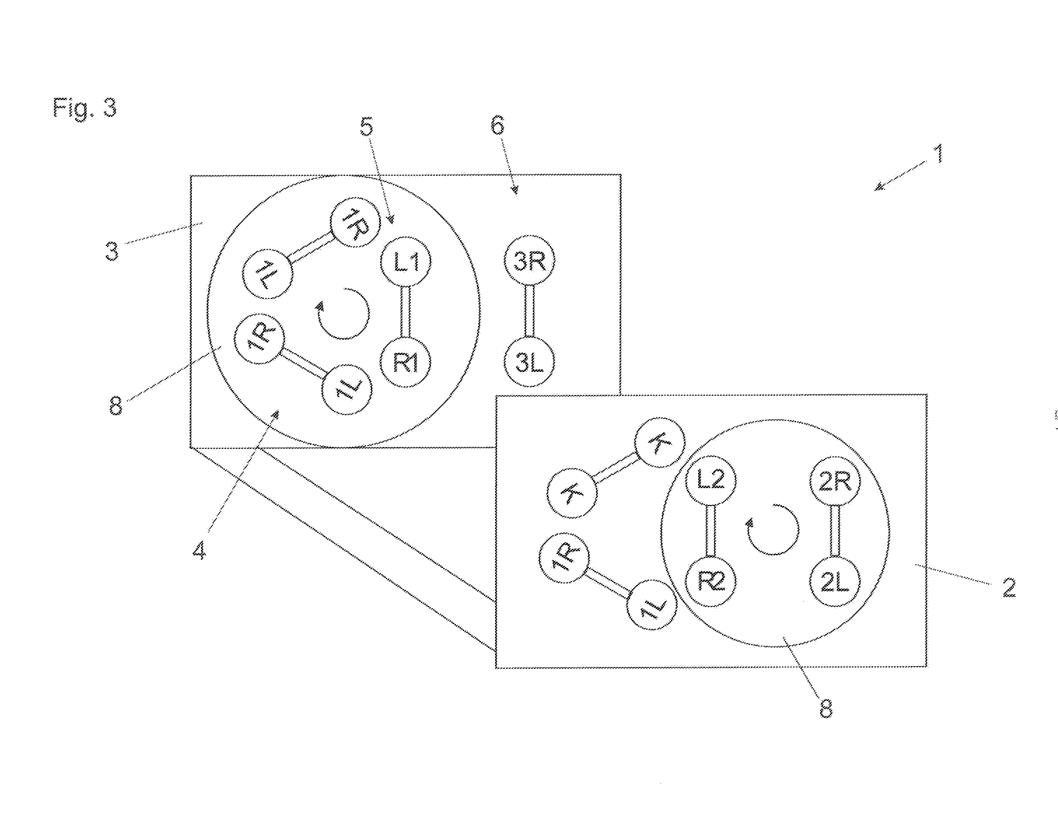

FIG. 3 shows an embodiment of the invention wherein there are also two turntables and one of the turntables forms/serves as a cooling station, and

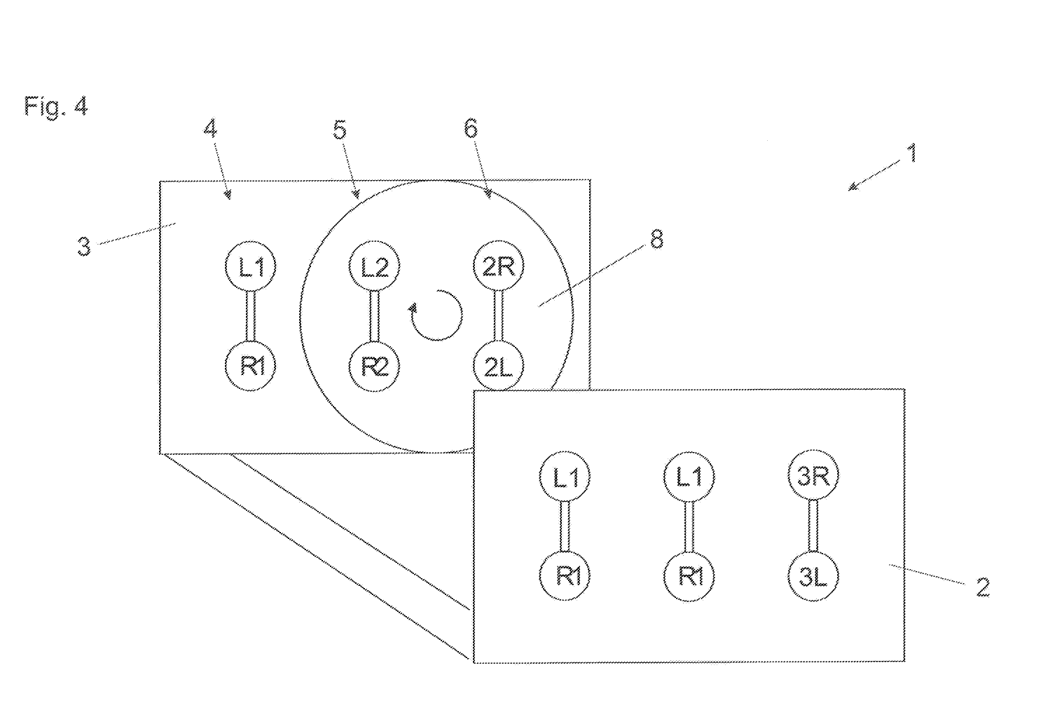

FIG. 4 shows an embodiment of the invention with a handling robot and a turntable.

FIG. 1 diagrammatically shows a molding tool 1 comprising a first mold half 2 and a second mold half 3. The molding tool 1 is shown open. A first injection station 4, a second injection station 5 and a third injection station 6 are arranged at the separation plane of the molding tool.

Three layers of two lenses are produced in the three injection stations. As for this specific case the use for motor vehicle headlights is intended, the paired production of the lenses is found to be advantageous.

The shaping parts of the individual stations are identified as follows:
1R shaping part for a first layer of a right lens;
1L shaping part for a first layer of a left lens;
2R shaping part for a second layer of a right lens;
2L shaping part for a second layer of a left lens;
3R shaping part for a third layer of a right lens; and
3L shaping part for a third layer of a left lens.

In the first injection station 4 the shaping parts identified by 1R and 1L are opposite to each other. After the molding tool 1 is closed the first layer is injected in the cavities produced thereby. That first layer is then transported by means of the first transport device to the correspondingly shaped parts of the second injection station 5, in which respect different configurations for transport devices are shown in FIGS. 2 through 4. The orientation of the shaping parts relative to each other is indicated by the orientation of the references 1R, L through 3R, L. In particular the orientation of the second injection station 5 is ‘turned’ through 180°. After the molding tool 1 is closed therefore the 1R-, 1L-cavity parts with first layer disposed therein and the cavity parts identified by 2R and 2L are in opposite relationship. The second layer is then injected into the free space produced thereby on the 2R-, 2L-side. That second layer already defines a surface of the lens to be produced. In this embodiment it is provided that this surface is removed only once from a mold and is thereafter not arranged on a mold again as this can lead to damage to the surface of the lens.

The first layer together with the second layer is then conveyed from the second injection station 5 into the third injection station 6. In regard to the design configurations of the transport devices, reference should again be made to FIGS. 2 through 4. After the molding tool has been closed again the shaping parts are disposed in opposite relationship, as identified by 2R and 2L, and by 3R and 3L respectively. Once again this gives an enlarged cavity, with the third layer being injected in the free space. After that third injection operation the lens is finished and can be removed from the mold, after the molding tool 1 is opened.

FIG. 2 shows a first example for the configuration of the transport devices. In this case two turntables 8 are used, wherein one of the turntables 8 is arranged at the first mold half 2 and one of the turntables 8 is arranged at the second mold half 3. Theoretically it is also possible with this structure to incorporate a cooling station—by removal and re-insertion into the shaping parts identified by 1R and 1L of the first injection station 4 or the second injection station 5. If cooling is to be effected however the embodiments of FIGS. 3 and 4 are preferred. All shaping parts can be temperature-controlled in variothermal relationship, that is to say they can be so temperature-controlled that their target temperature experiences a change during a production cycle. In that respect firstly a relatively high temperature is generally adopted to promote injection of a plasticised plastic or the like and thereafter cooling is implemented to accelerate hardening of the respective layer.

The embodiment of FIG. 3 also uses two turntables 8 for transport of the layers. Unlike the above-described embodiment the turntable 8 arranged at the second mold half 3 has an additional position, wherein this also finds a counterpart identified by K on the first mold half 2. That additional position serves for cooling. The first layer is therefore cooled after production for the length of a cycle in the cooling station K.

Otherwise this embodiment is similar to that of FIG. 2.

This also applies to the embodiment of FIG. 4 with the difference that, for transporting the first layers to the second injection station 5, the arrangement does not use a turntable 8 but a handling robot (not shown). With this embodiment it can be provided that the first layers after production are transferred into an external cooling station before they are fitted again into the parts of the second injection station 5, identified by 1R and 1L. The advantage of this external cooling station is that the cooling time is not laid down by the cycle time. In actual fact cooling can also be effected over two or more cycles in length, whereby the cooling time can be relatively well adjusted.

In this respect also there is the advantage that finished shaped surfaces of the lens do not have to be put into a mold cavity again, after having been removed from the mold.

For that reason and because of the adjustability of the cooling time this embodiment can be a preferred one. A further advantage of the invention is that the production of optical elements can also be carried out with only one single injection unit.

The injection stations 4, 5 and 6 in the Figures can be so designed that they are all a component part of a tool. It is however also possible for each injection station to be formed by its own tool (=3 tools in mutually juxtaposed relationship).

For the turntables 8 in FIG. 2 and FIG. 3, the turntables 8 are either a component part of the machine or a component part of the tool.

In FIG. 4 there is again the possibility of the turntable 8 being a component part of the tool or of the machine. In addition the embodiment could also be implemented with only one tool. There is however also the possibility of implementing the embodiment in such a way that the first injection station is produced with one tool, and a second tool forms the injection stations 2 and 3. The second tool would then also include the turntable.

It should be pointed out that, instead of the expression ‘turntable’, the jargon in the art also uses the expression ‘rotary disk’. What is meant at any event is a device which carries at least two shaping halves of a respective cavity and which is rotatable in such a way that one of the shaping halves can be positioned on at least two different counterparts. The turntable itself can be a component part of the tool or the machine.

1. A molding tool for the production of an optical element comprising
a first mold half,
a second mold half separated from the first mold half by a separation plane,
a first injection station arranged at the separation plane for shaping a first layer of the optical element to be produced,
a second injection station arranged at the separation plane in which a second layer of the optical element to be produced can be injected on to the first layer, and
a first transport device for transporting the first layer from the first injection station into the second injection station,
wherein a third injection station which is arranged at the separation plane and in which a third layer of the optical element to be produced can be injected on to the first layer and/or the second layer, wherein the first layer together with the second layer injected thereon can be transported out of the second injection station to the third injection station by means of a separate second transport device.

2. A molding tool as set forth in claim 1, wherein the third injection station is so designed that the third layer can be injected in the third injection station on a side of the first layer, that faces away from the second layer.

3. A molding tool as set forth in claim 1, wherein the first injection station is adapted to produce the first layer in at least two sub-layers.

4. A molding tool as set forth in claim 1, wherein the first transport device includes a handling robot, by means of which the first layer can be transported from the first injection station to the second injection station.

5. A molding tool as set forth in claim 1, wherein the first transport device includes a turntable, by means of which the first layer can be transported from the first injection station to the second injection station.

6. A molding tool as set forth in claim 1, wherein the first layer can be transported by means of the first transport device—preferably a handling robot or a turntable from the first injection station to a cooling station and from the cooling station to the second injection station.

7. A molding tool as set forth in claim 6, wherein the cooling station is arranged outside the molding tool.

8. A molding tool as set forth in claim 6, wherein the cooling station is formed by a position of the turntable.

9. A molding tool as set forth in claim 1, wherein the second transport device is adapted to move a part of the second injection station, that shapes the second layer, for transport of the first layer together with the second layer injected thereon, to the third injection station.

10. A molding tool as set forth in one claim 1, wherein the second transport device includes a turntable, by means of which the first layer can be transported together with the second layer injected thereon from the second injection station into the third injection station.

11. A molding tool as set forth in claim 1, wherein the first injection station is so designed that at least two first layers can be shaped.

12. A molding tool as set forth in claim 1, wherein the second injection station is so designed that at least two second layers can be injected on to two first layers.

13. A molding tool as set forth in claim 1, wherein the third injection station is so designed that at least two third layers can be injected on to at least two first layers and/or at least two second layers.

14. A molding tool as set forth in claim 1, wherein the molding tool is adapted to produce a lens as the optical element.

15. An injection molding machine having a molding tool as set forth in claim 1.

16. A process for the production of an optical element by a molding tool as set forth in claim 1, wherein
a first layer of the optical element to be produced is shaped in a first injection station arranged at a separation plane of the molding tool,
the first layer is transported by means of a first transport device to a second injection station arranged at the separation plane of the molding tool, and
a second layer of the optical element to be produced is injected on to the first layer in the second injection station,
wherein
the first layer together with the second layer injected thereon is transported out of the second injection station to a third injection station arranged at the separation plane by means of a separate second transport device, and
a third layer of the optical element to be produced is injected on to the first layer and/or the second layer.
